(19) United States
(12) Patent Application Publication
(10) Pub. No.: US 2026/0231165 A1
(43) Pub. Date: Aug. 6, 2026

(54) METHOD AND APPARATUS FOR TA ACQUISITION

(71) Applicant: LENOVO (BEIJING) LIMITED, Beijing (CN)

(72) Inventors: Lianhai WU, Beijing (CN); Mingzeng DAI, Shanghai (CN); Congchi ZHANG, Shanghai (CN); Bingchao LIU, Beijing (CN)

(21) Appl. No.: 19/152,533

(22) PCT Filed: May 11, 2023
(86) PCT No.: PCT/CN2023/093574

§ 371 Date: Jul. 31, 2025

(51) Int. Cl. H04W 72/23; H04W 36/00; H04W 74/0833

(52) U.S. Cl. CPC H04W 72/23; H04W 36/0072; H04W 74/0833

(57) ABSTRACT

Embodiments of the present disclosure relate to methods and apparatuses for early timing advance (TA) acquisition. According to some embodiments of the disclosure, a first distributed unit (DU) of a base station (BS) may: receive, from a centralized unit (CU) of the BS, configuration information regarding early TA acquisition with a candidate cell for cell switching; and transmit, to a user equipment (UE) served by the first DU, a physical downlink control channel (PDCCH) order associated with the candidate cell, wherein the PDCCH order triggers the UE to transmit a signal (e.g., a preamble) to the candidate cell via the configured random access channel (RACH) occasion.

### TECHNICAL FIELD

Embodiments of the present disclosure generally relate to wireless communication technology, and more particularly to methods and apparatuses for timing advance (TA) acquisition.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

There is a need for handling TA acquisition in a wireless communication system.

### SUMMARY

Some embodiments of the present disclosure provide a first distributed unit (DU) of a base station (BS). The first DU may include a transceiver; and a processor coupled to the transceiver. The processor may be configured to: receive, from a centralized unit (CU) of the BS, configuration information regarding early timing advance (TA) acquisition with a candidate cell for cell switching; and transmit, to a user equipment (UE) served by the first DU, a physical downlink control channel (PDCCH) order associated with the candidate cell, wherein the PDCCH order triggers the UE to transmit a signal (e.g., a preamble) to the candidate cell. For example, the signal (e.g., a preamble) may be transmitted via a configured random access channel (RACH) occasion.

In some embodiments, the processor may be further configured to, in response to transmitting the PDCCH order: receive a TA value related to the candidate cell from the candidate cell; and perform one of the following: receiving, from the candidate cell, a first indication indicating whether the TA value is to be transmitted to the UE via a random access response (RAR), a medium access control (MAC) control element (CE) or a cell switching command, and transmitting the TA value to the UE according to the first indication; transmitting the TA value to the UE via the cell switching command in the case that the first DU does not receive the first indication; receiving, from the CU, a second indication indicating whether the TA value is to be transmitted to the UE via the RAR, a MAC CE or the cell switching command, and transmitting the TA value to the UE according to the second indication; transmitting the TA value to the UE via the cell switching command in the case that the first DU does not receive the second indication; transmitting the TA value to the UE via the RAR in the case that the first DU receives RAR related information from the CU or the candidate cell; or transmitting the TA value to the UE via the cell switching command in the case that the first DU does not receive any RAR related information.

In some embodiments, the processor may be further configured to receive RAR related information from a candidate DU via the CU, or configure the RAR related information for the UE; and transmit the RAR related information to the UE for monitoring an RAR carrying a TA value from a serving cell of the UE.

In some embodiments, the RAR related information may include a length of an RAR window for monitoring the RAR, an offset associated with the RAR window, or both.

In some embodiments, the processor may be further configured to: receive a TA value related to the candidate cell from the candidate cell in response to transmitting the PDCCH order; and transmit the TA value to the UE via an RAR using one of a cell radio network temporary identifier (C-RNTI), a random access RNTI (RA-RNTI) or a specific RNTI associated with a serving cell of the UE.

In some embodiments, in the case that the first DU is indicated to transmit a TA value related to the candidate cell to the UE via an RAR while the first DU transmits a cell switching command related to the candidate cell to the UE, the processor may be further configured to: transmit the cell switching command including the TA value and skip the transmission of the RAR; transmit the cell switching command without the TA value and skip the transmission of the RAR; or multiplex the cell switching command and the RAR into the same MAC layer data unit.

Some embodiments of the present disclosure provide a user equipment (UE). The UE may include a transceiver, and a processor coupled to the transceiver. The processor may be configured to: receive a physical downlink control channel (PDCCH) order associated with a candidate cell for cell switching; transmit a signal (e.g., a preamble) to the candidate cell in response to receiving the PDCCH order; and receive a timing advance (TA) value related to the candidate cell via a first distributed unit (DU) of a base station (BS), wherein the UE is served by the first DU.

In some embodiments, the processor may be further configured to receive RAR related information from a CU of the BS or the first DU, and wherein the RAR related information is configured by the candidate cell or the first DU.

In some embodiments, the RAR related information may include a length of an RAR window for monitoring an RAR carrying the TA value, an offset associated with the RAR window, or both. In some embodiments, a starting time of the RAR window is based on the offset and a duration of the RAR window is based on the length of the RAR window. In some embodiments, the duration of the RAR window is based on the offset and the length of the RAR window.

In some embodiments, the processor may be further configured to, in response to a successful reception of the TA value, transmit an indication of successful reception of the TA value to the BS. In some embodiments, the processor may be further configured to, in response to an unsuccessful reception of the TA value, transmit an indication of an unsuccessful reception of the TA value to the BS. In some embodiments, the indication may be transmitted via a L1 indication, an MAC CE, or an RRC message.

In some embodiments, the TA value may be received via an RAR. In some embodiments, the UE does not expect to receive another TA value related to the candidate cell in a cell switching command related to the candidate cell. In some embodiments, the processor may be further configured to receive the another TA value in the cell switching command and replace the TA value stored at the UE with the another TA value.

In some embodiments, the processor may be further configured to: receive another PDCCH order associated with the candidate cell, wherein the another PDCCH order triggers a TA re-acquisition; and delete stored TA value related to the candidate cell in response to receiving the another PDCCH order.

In some embodiments, the processor may be further configured to: receive, from the BS, a RACH configuration for the early TA acquisition associated with the candidate cell; and perform a compliance check on the RACH configuration.

In some embodiments, the compliance check may be performed in response to the reception of the RACH configuration or in response to the reception of the PDCCH order.

In some embodiments, the processor may be further configured to report failure information indicating one of the following to the BS in response to a failure in the compliance check: a compliance check failure, a reconfiguration failure, a reference configuration failure, a RACH configuration failure for early TA acquisition, a complete lower layer triggered mobility (LTM) configuration failure.

In some embodiments, the TA value may be received via an RAR using a C-RNTI, a RA-RNTI or a specific RNTI associated with a serving cell of the UE.

Some embodiments of the present disclosure provide a second distributed unit (DU) of a base station (BS). The second DU may include a transceiver, and a processor coupled to the transceiver. The processor may be configured to: receive, from a centralized unit (CU) of the BS, a request for cell switching associated with a candidate cell; transmit, to the CU, a response, wherein the response may include configuration information associated with the candidate cell; receive, from a user equipment (UE) severed by a first DU of the BS, a signal (e.g., a preamble) for early timing advance (TA) acquisition related to the candidate cell; and transmit, to the first DU via the CU, a TA value related to the candidate cell in response to the reception of the signal.

In some embodiments, the request may indicate that an RAR, an MAC CE or a cell switching command is used to carry the TA value.

In some embodiments, the processor may be further configured to transmit a first indication indicating whether the TA value is to be transmitted to the UE via an RAR, an MAC CE or a cell switching command in response to the reception of the signal.

In some embodiments, the response may further include a length of an RAR window for monitoring an RAR carrying the TA value, an offset associated with the RAR window, or both.

In some embodiments, a starting time of the RAR window is based on the offset and a duration of the RAR window is based on the length of the RAR window. In some embodiments, the duration of the RAR window is based on the offset and the length of the RAR window.

Some embodiments of the present disclosure provide a method performed by a first distributed unit (DU) of a base station (BS). The method may include: receiving, from a centralized unit (CU) of the BS, configuration information regarding early timing advance (TA) acquisition with a candidate cell for cell switching; and transmitting, to a user equipment (UE) served by the first DU, a physical downlink control channel (PDCCH) order associated with the candidate cell, wherein the PDCCH order triggers the UE to transmit a signal to the candidate cell.

Some embodiments of the present disclosure provide a method performed by a user equipment (UE). The method may include: receiving a physical downlink control channel (PDCCH) order associated with a candidate cell for cell switching; transmitting a signal to the candidate cell in response to receiving the PDCCH order; and receiving a timing advance (TA) value related to the candidate cell via a first distributed unit (DU) of a base station (BS), wherein the UE is served by the first DU.

Some embodiments of the present disclosure provide a method performed by a second distributed unit (DU) of a base station (BS). The method may include: receiving, from a centralized unit (CU) of the BS, a request for cell switching associated with a candidate cell; transmitting, to the CU, a response, wherein the response may include configuration information associated with the candidate cell; receiving, from a user equipment (UE) severed by a first DU of the BS, a signal for early timing advance (TA) acquisition related to the candidate cell; and transmitting, to the first DU via the CU, a TA value related to the candidate cell in response to the reception of the signal.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of an exemplary BS in accordance with some embodiments of the present disclosure;

FIGS. 3-6 illustrate flow charts of an exemplary procedure for early TA acquisition in accordance with some embodiments of the present disclosure;

FIGS. 7-9 illustrate flow charts of an exemplary procedure of wireless communications in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

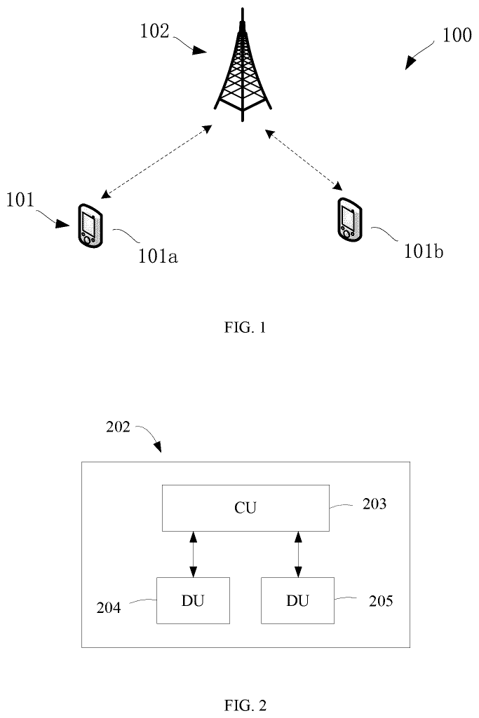

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

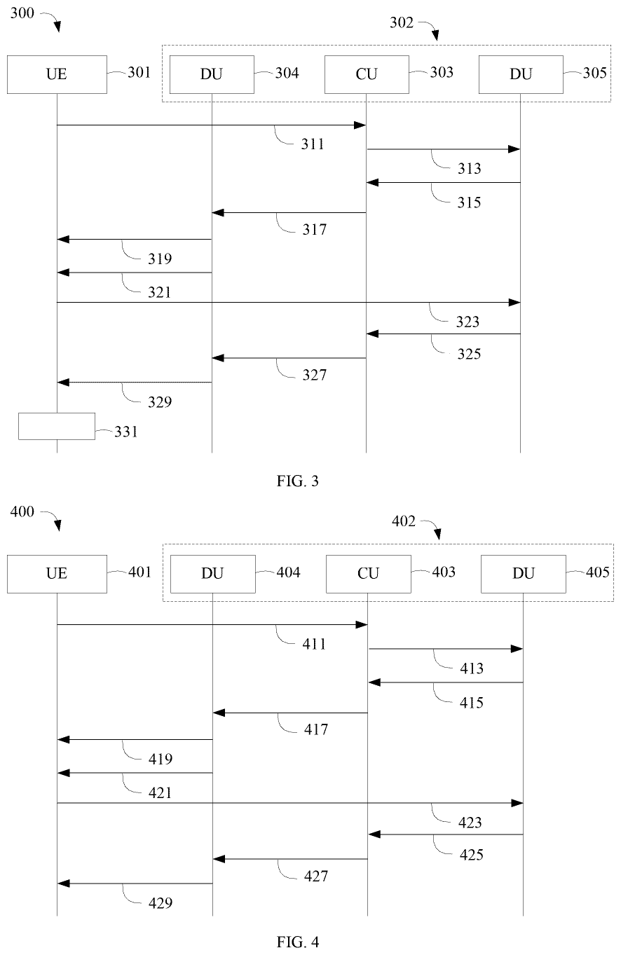

In some embodiments of the present disclosure, a BS (e.g., BS 102 in FIG. 1) may include a CU (also referred to as BS-CU) and one or more DUs (also referred to as BS-DUs). For example, as shown in FIG. 2, BS 202 may include CU 203, DU 204 and DU 205. It is contemplated that BS 202 may include more or less DUs in some other embodiments of the present disclosure.

Each of DU 204 and DU 205 may include one or more cells, which may also be referred to the cells of BS 202. DU 204 and DU 205 may communicate with CU 203 via an F1 interface.

A UE (not shown in FIG. 2) may access BS 202. That is, BS 202 is a serving BS of the UE. The UE may have one or more serving cells, which may belong to the same or different DUs. For example, a serving cell of the UE may be a cell of DU 204. In such example, DU 204 may be referred to as a serving DU of the UE.

In some embodiments of the present disclosure, a communication system (e.g., NR) may support layer1/layer2 (L1/L2) based inter-cell mobility, which may also be referred to as “lower layer triggered mobility (LTM)”.

For example, a UE may access a BS (i.e., serving BS). The UE may report layer 3 (L3, such as radio resource control (RRC)) measurement results based on the configuration from the serving BS. The BS (e.g., the CU of BS) may decide to switch the UE to a candidate cell(s) based on the measurement results. In some examples, a candidate cell and the current serving cell of the UE may belong to the same DU of the serving BS (i.e., intra-DU cell switch). In some examples, a candidate cell and the current serving cell of the UE may belong to different DUs of the serving BS (i.e., inter-DU cell switch). The DU having the current serving cell of the UE can be referred to as a source DU and the DU having the candidate cell can be referred to a candidate/target DU. The serving BS may request the corresponding candidate/target DU(s) to prepare the configuration for one or more candidate cells.

In response to receiving the configuration for the one or more candidate cells from the candidate/target DU(s), the serving BS may transmit an RRC reconfiguration message indicating the one or more candidate cells (e.g., including the received configuration) to the UE. For example, the CU of the serving BS may transmit an RRC reconfiguration message to the UE via the source DU. The UE may transmit an RRC reconfiguration complete message to the serving BS (e.g., CU) via the source DU.

In some embodiments of the present disclosure, the UE may ensure UL/DL sync before receiving a cell switching command (e.g., switching from the serving cell to a candidate cell). For example, the UE may obtain a (early) TA via a random access or a preamble transmission. This may be referred to as early TA acquisition. That is, the UE may perform a TA acquisition procedure before the cell switching procedure. The UE may report L1 measurement results to the serving BS (e.g., the source DU) for dynamic switching purpose. For example, the L1 measurement results may be associated with the one or more candidate cells. The serving BS may determine to perform a cell switch based on the measurement results. For example, the serving BS (e.g., the source DU) may transmit, to the UE, a cell switching command (e.g., a L1/L2 triggered mobility cell switch command) via, for example, an MAC CE or downlink control information (DCI). The UE can apply the RRC reconfiguration message and start a timer in response to the reception of the lower layer command.

Embodiments of the present disclosure provide solutions to handle various issues associated with early TA acquisition. For example, how to transmit the (early) TA value from a source DU to a UE need to be addressed. For instance, solutions for determining whether the TA value should be carried in a random access response (RAR) or a cell switching command are provided. For example, a UE may monitor the RAR in an RAR window. Solutions for determining the RAR window are provided. For example, a collision may occur between an RAR and a cell switching command. Solutions for solving the collision are provided. For example, a (early) TA value related to a certain candidate cell may already be stored at a UE while the UE may be triggered for TA re-acquisition with the same candidate cell or the UE may receive another TA value related to the same candidate cell (e.g., in a cell switching command). Solutions for handling the above scenario at a UE side are provided. For example, solutions for handling a compliance check on configurations associated with the early TA acquisition are provided. More details will be illustrated in following text in combination with the appended drawings.

In the context of the present disclosure, inter-DU mobility means that while a UE maintains its connection with the same CU, the UE is handed over from a source cell of a source DU to a target cell of a target DU, wherein both the source DU and the target DU are managed by the same CU. Intra-DU mobility means that while a UE maintains its connection with the same CU, the UE is handed over from a source cell to a target cell, wherein both the source and target cells belong to the same DU. For clarity, embodiments of the present disclosure may be described with respect to the inter-DU mobility scenario (e.g., inter-BS-DU LTM). Persons skilled in the art can readily understand that these embodiments can be similarly applied to the intra-DU mobility scenario (e.g., intra-BS-DU LTM), for example, with minor modifications that are apparent to those skilled in the art.

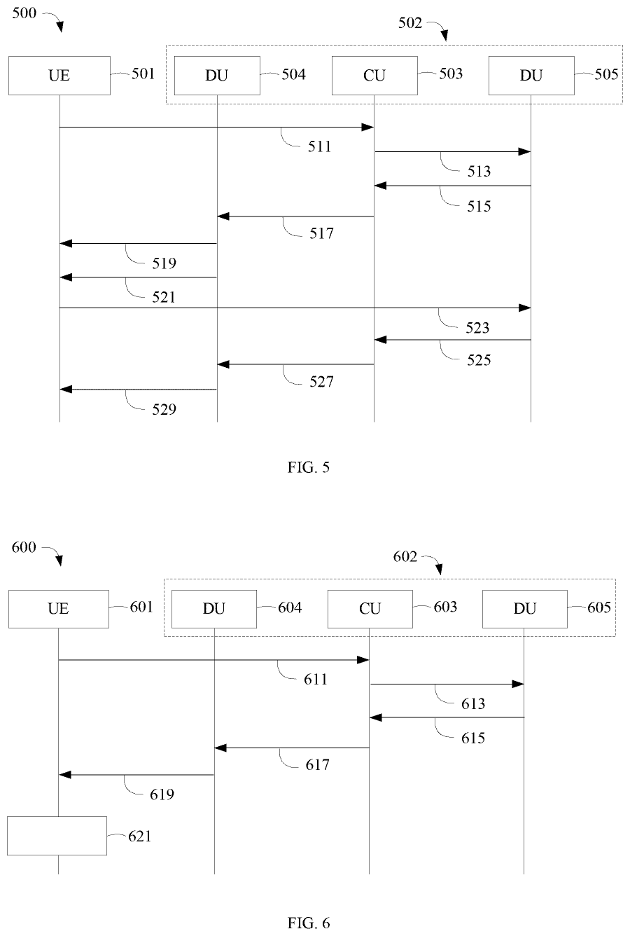

FIG. 3 illustrates a flow chart of exemplary procedure 300 for early TA acquisition in accordance with some embodiments of the present disclosure. Details described in all of the foregoing embodiments of the present disclosure are applicable for the embodiments shown in FIG. 3.

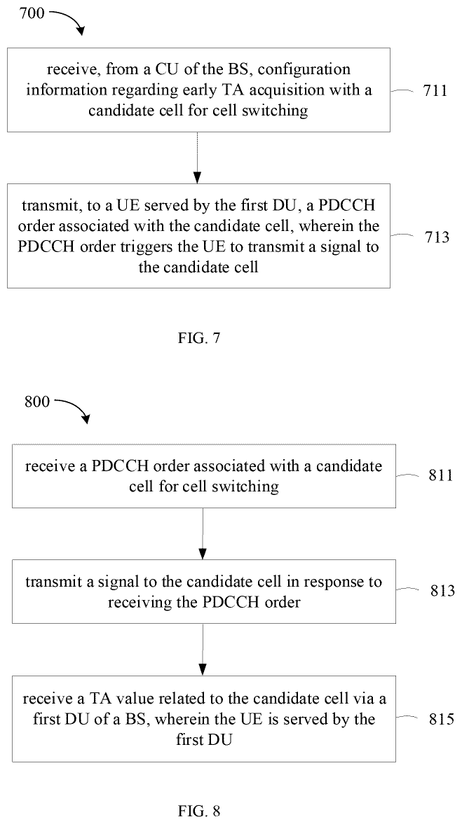

As shown in FIG. 3, in operation 311, UE 301 may access BS 302 (i.e., serving BS) and may transmit a measurement report to BS 302. BS 302 may include a CU (i.e., CU 303) and at least one DU (e.g., DU 304 and DU 305). BS 302 may include one or more DUs (not shown in FIG. 7) other than DU 304 and DU 305. Each of DU 304 and DU 305 may include one or more cells, which can also be referred to as the cells of BS 302. UE 301 may be served by a cell of DU 304; and this cell can be referred to as the serving cell of UE 301 and DU 304 can be referred to as the serving DU of UE 301 and can be referred to as the source DU of UE 301.

In operation 313, BS 302 (e.g., CU 303) may determine to initiate a L1/L2 based inter-cell mobility configuration (e.g., LTM configuration) and transmit a request message (e.g., a UE CONTEXT SETUP REQUEST message) to one or more candidate DUs (e.g. DU 305) which are associated with one or more candidate cells. In some embodiments, the request message may indicate an early TA acquisition. That is, a TA value related to a candidate cell may be acquired before the cell switch procedure associated with the candidate cell.

In some embodiments, early TA acquisition with an RAR from the serving cell or early TA acquisition without an RAR may be indicated to the candidate DUs. For example, the request message may indicate that an RAR, a cell switching command, or an MAC CE is used to carry the TA value.

If DU 305 decides to accept the request of LTM configuration related to a candidate cell (i.e., a cell of DU 305), DU 305 may generate a lower layer RRC configuration for the accepted candidate cell. In operation 315, DU 305 may transmit a response message including the generated lower layer RRC configuration (also referred to as “candidate cell configuration for LTM”) to CU 303. In some embodiments, random access channel (RACH) resource for early TA acquisition may be included in the response message. In some embodiments, the response message may be a UE CONTEXT SETUP RESPONSE message.

In some embodiments, DU 305 may configure RAR related information (or RAR related configuration) for the early TA acquisition. In some examples, DU 305 may transmit the RAR related information to DU 304 via CU 303. For example, the RAR related information may be transmitted to CU 303 in operation 315 (e.g., in the response message), and then may be transmitted from CU 303 to DU 304 in operation 317. DU 304 may transmit the RAR related information to UE 301. In some examples, the RAR related information may be transmitted to CU 303 and then may be transmitted from CU 303 to UE 301 (e.g., via RRC).

In some embodiments, the RAR related information may include a length of an RAR window (e.g., ra-responsewindow) for monitoring an RAR (which may carry a TA value), an offset associated with the RAR window, or both. For example, the RAR related information may be included in a ra-Response Window information element (IE). The details of the RAR window will be described later. In some other embodiments as will be described later, the RAR related information may be configured by a source DU (e.g., DU 304) or a serving cell, instead of a candidate DU (e.g., DU 305) or a candidate cell.

In operations 317 and 319, CU 303 may transmit the received configurations to DU 304 (source DU) and UE 301. For example, in some embodiments, CU 303 may generate an RRC reconfiguration message based on the received configuration(s) for the candidate cell(s). For example, the RRC reconfiguration message may include the candidate cell configuration(s) for LTM, the RACH resource for early TA acquisition, the RAR related information (if configured by the candidate DU (e.g., DU 305) or candidate cell) or any combination thereof. In operations 317 and 319, CU 303 may transmit the generated configuration to DU 304 (source DU) and UE 301. For example, CU 303 may transmit the generated configuration to UE 301 via DU 304. In some embodiments, CU 303 may further indicate whether early TA acquisition should be triggered.

In some embodiments, the RAR related information may be configured by DU 304 (i.e., source DU). For example, DU 304 may configure the time window (e.g., ra-responsewindow) for monitoring an RAR (which may carry a TA value). For example, the RAR related information may include a length of the RAR window, an offset associated with the RAR window, or both. For example, the RAR related information may be included in a ra-ResponseWindow IE. In some examples, the RAR related information may be transmitted to UE 301 via an MAC CE from the serving DU or serving cell. In some examples, the RAR related information may be transmitted to CU 303, which may transmit the information to UE 301 via RRC.

In operation 319, UE 301 may receive the RRC configuration message associated with one or more candidate cells for LTM configuration.

In operation 321, UE 301 may receive, from its serving cell or serving DU (e.g., DU 304), an indication for triggering TA acquisition to a specific candidate cell among the one or more candidate cells. The indication may be a PDCCH order associated with the candidate cell. For simplicity, it is assumed that the candidate cell is a cell of DU 305 (candidate DU). In response to the PDCCH order, UE 301 may, in operation 323, transmit a signal (e.g., a preamble for (early) TA acquisition) to DU 305 (i.e., to the corresponding candidate cell).

In response to receive the signal (e.g., the preamble), DU 305 (or the candidate cell) may transmit a TA value related to the candidate cell to CU 303 in operation 325. CU 303 may store the TA value received from DU 305 (or candidate cell). For example, in the case that DU 305 (or the candidate cell) can calculate or generate a TA value related to the candidate cell based on the received preamble, DU 305 (or the candidate cell) may transmit the calculated TA value to CU 303. DU 305 may store the TA value.

In some embodiments, DU 305 (or the candidate cell) may also transmit one of more of: the received preamble, the corresponding RACH occasion, beam indication, UE ID, random access-cell radio network temporary identifier (RA-RNTI), target cell ID (i.e., the ID of the candidate cell) and transmission configuration indication (TCI) state index for the target cell, and other necessary information to CU 303.

In operation 327, CU 303 may transmit the information received from DU 305 in operation 325 to DU 304 (source DU). For example, CU 303 may transfer the received information to DU 304 via F1 interface. As stated above, the received information may include the TA value related to the candidate cell. DU 304 may store the received TA value. In some embodiments, DU 304 (source DU) may determine how to transmit the TA value to the UE. For example, DU 304 (source DU) may need to know whether the TA value should be transmitted in an RAR, a cell switching command or any other MAC CE. DU 304 (source DU) may make the determination based on explicit or implicit indication.

For example, in some embodiments, DU 305 (or candidate cell) may transmit an indication (denoted as indication #1 for clarity) indicating whether the TA value is to be transmitted to a UE via an RAR, an MAC CE or a cell switching command to DU 304 (source DU) via CU 303 (e.g., in operations 325 and 327). Then, DU 304 may transmit the TA value to UE 301 according to indication #1 (e.g., in operation 329). In the case that DU 304 does not receive indication #1, DU 304 may transmit the TA value to UE 301 in a cell switching command (e.g., in operation 329). For example, the cell switching command may include a TA value field for the target cell, which may be used to carry the TA value.

For example, in some embodiments, CU 303 may transmit an indication (denoted as indication #2 for clarity) indicating whether the TA value is to be transmitted to a UE via an RAR, an MAC CE or a cell switching command to DU 304 (source DU) (e.g., in operation 327). Then, DU 304 may transmit the TA value to UE 301 according to indication #2 (e.g., in operation 329). In the case that DU 304 does not receive indication #2, DU 304 may transmit the TA value to UE 301 in a cell switching command (e.g., in operation 329). For example, the cell switching command may include a TA value field for the target cell, which may be used to carry the TA value.

For example, in some embodiments, DU 304 may determine whether to transmit the TA value via an RAR, an MAC CE or a cell switching command based on whether DU 304 has received any RAR related information. For example, in the case that DU 304 receives RAR related information from CU 303 or DU 305 (or candidate cell), DU 304 may transmit the TA value to UE 301 in an RAR (e.g., in operation 329). In the case that DU 304 does not receive any RAR related information, DU 304 may transmit the TA value to UE 301 in a cell switching command (or any other dedicate MAC CE) (e.g., in operation 329).

The descriptions regarding the RAR related information in the forgoing embodiments may also apply here. In some examples, the RAR related information may include one or more of: information related to the RAR window (e.g., length, offset, or both) or the RNTI (e.g., RA-RNTI or any other specific RNTI) to be used in the serving cell for receiving the RAR. In some embodiments, DU 304 (serving DU) may configure UE 301 to receive an RAR in the serving cell, for example, using the RAR related information.

In operation 329, UE 301 may receive the TA value from DU 304 (or serving cell) and may store the received TA value. For example, UE 301 may receive the TA value from DU 304 (or serving cell) via an RAR, an MAC CE or a cell switching command. In the case that an RAR is used to carry the TA value, UE 301 may receive (or DU 304 may transmit) the TA value using one of a cell-RNTI (C-RNTI), a RA-RNTI or a specific RNTI, which are associated with the serving cell of UE 301.

In some embodiments, UE 301 may determine an RAR window for monitoring the RAR based on the RAR related information. For example, as described above, the RAR related information may include a length of an RAR window for monitoring the RAR, an offset associated with the RAR window, or both. In some embodiments, the offset may be in units of symbols, slots, or milliseconds or any other time units. In some embodiments, the offset may cover the radio frequency (RF) switching time at least for the inter-frequency case. In some embodiments, the offset may be zero for the intra-frequency case.

In some embodiments, a starting time of the RAR window may be based on the offset and a duration of the RAR window may be based on the length of the RAR window. For example, the RAR window may start at the first symbol of the earliest control resource set (CORESET) UE 301 is configured to receive a PDCCH for Typel-PDCCH common search space (CSS) set that is at least one symbol plus the offset after the last symbol of the PRACH occasion corresponding to the PRACH transmission (e.g., the preamble transmission in operation 323). The duration of the RAR window may be equal to the length of the RAR window.

In some embodiments, the duration of the RAR window may be based on the offset and the length of the RAR window. For example, the RAR window may start at the first symbol of the earliest CORESET UE 301 is configured to receive a PDCCH for Typel-PDCCH CSS set that is at least one symbol after the last symbol of the PRACH occasion corresponding to the PRACH transmission. The duration of the RAR window may be equal to the length of the RAR window plus the offset.

In some embodiments, the offset may be predefined (e.g., fixed or specified in a 3GPP standard). The RAR related information may not indicate the offset. For example, the RAR window may start at the first symbol of the earliest CORESET UE 301 is configured to receive a PDCCH for Type1-PDCCH CSS set that is at least a certain time period after the last symbol of the PRACH occasion corresponding to the PRACH transmission. The certain time period may be predefined (e.g., fixed or specified in a 3GPP standard) as x milliseconds, y slots, or z symbols. The duration of the RAR window may be equal to the length of the RAR window.

In some embodiments, the length of the RAR window may already take the offset into account. The RAR window may start at the first symbol of the earliest CORESET UE 301 is configured to receive a PDCCH for Typel-PDCCH CSS set that is at least one symbol after the last symbol of the PRACH occasion corresponding to the PRACH transmission. The duration of the RAR window may be equal to the length of the RAR window.

In some embodiments, UE 301 may perform cell switch in operation 331 in response to receiving a cell switching command. The network (e.g., a source DU such as DU 304, a CU such as CU 303, a candidate DU such as DU 305) may maintain or store the TA value received from the candidate DU (e.g., DU 305), regardless of whether the TA is transmitted to a UE via the RAR option or non-RAR option. After UE 301 switches to a target cell (e.g., cell #1), UE 301 may release the stored (early) TA value related to the target cell (e.g., cell #1). After UE 301 switches to a target cell (e.g., cell #1), the network node (e.g., a source DU such as DU 304, a CU such as CU 303, a candidate DU such as DU 305) having the TA value may transmit the stored (early) TA value to the new source cell (e.g., cell #1) UE 301 switches to.

It should be appreciated by persons skilled in the art that the sequence of the operations in exemplary procedure 300 may be changed and that some of the operations in exemplary procedure 300 may be eliminated or modified, without departing from the spirit and scope of the disclosure.

FIG. 4 illustrates a flow chart of exemplary procedure 400 for early TA acquisition in accordance with some embodiments of the present disclosure. Details described in all of the foregoing embodiments of the present disclosure are applicable for the embodiments shown in FIG. 4.

As shown in FIG. 4, in operation 411, UE 401 may access BS 402 (i.e., serving BS) and may transmit a measurement report to BS 402. BS 402 may include a CU (i.e., CU 403) and at least one DU (e.g., DU 404 and DU 405). BS 402 may include one or more DUs (not shown in FIG. 7) other than DU 404 and DU 405. Each of DU 404 and DU 405 may include one or more cells, which can also be referred to as the cells of BS 402. UE 401 may be served by a cell of DU 404; and this cell can be referred to as the serving cell of UE 401 and DU 404 can be referred to as the serving DU of UE 401 and can be referred to as the source DU of UE 401.

In operation 413, BS 402 (e.g., CU 403) may determine to initiate a L1/L2 based inter-cell mobility configuration (e.g., LTM configuration) and transmit a request message (e.g., a UE CONTEXT SETUP REQUEST message) to one or more candidate DUs (e.g. DU 405) which are associated with one or more candidate cells. In some embodiments, the request message may indicate an early TA acquisition. That is, a TA value related to a candidate cell may be acquired before the cell switch procedure associated with the candidate cell.

If DU 405 decides to accept the request of LTM configuration related to a candidate cell (i.e., a cell of DU 405), DU 405 may generate a lower layer RRC configuration for the accepted candidate cell. In operation 415, DU 405 may transmit a response message including the generated lower layer RRC configuration (also referred to as “candidate cell configuration for LTM”) to CU 403. In some embodiments, RACH resource for early TA acquisition may be included in the response message. In some embodiments, the response message may be a UE CONTEXT SETUP RESPONSE message.

In operations 417 and 419, CU 403 may transmit the received configurations to DU 404 (source DU) and UE 401. For example, in some embodiments, CU 403 may generate an RRC reconfiguration message based on the received configuration(s) for the candidate cell(s). For example, the RRC reconfiguration message may include the candidate cell configuration(s) for LTM, the RACH resource for early TA acquisition, the RAR related information (if configured) or any combination thereof. In operations 417 and 419, CU 403 may transmit the generated configuration to DU 404 (source DU) and UE 401. For example, CU 403 may transmit the generated configuration to UE 401 via DU 404. In some embodiments, CU 403 may further indicate whether early TA acquisition should be triggered.

In operation 419, UE 401 may receive the RRC configuration message associated with one or more candidate cells for LTM configuration.

In operation 421, UE 401 may receive, from its serving cell or serving DU (e.g., DU 404), an indication for triggering TA acquisition to a specific candidate cell among the one or more candidate cells. The indication may be a PDCCH order associated with the candidate cell. For simplicity, it is assumed that the candidate cell is a cell of DU 405 (candidate DU). In response to the PDCCH order, UE 401 may, in operation 423, transmit a signal (e.g., a preamble for (early) TA acquisition) to DU 405 (i.e., to the corresponding candidate cell).

In response to receive the signal (e.g., the preamble), DU 405 (or the candidate cell) may transmit a TA value related to the candidate cell to CU 403 in operation 425. For example, in the case that DU 405 (or the candidate cell) can calculate or generate a TA value related to the candidate cell based on the received preamble, DU 405 (or the candidate cell) may transmit the calculated TA value to CU 403. In some embodiments, DU 405 (or the candidate cell) may also transmit one of more of: the received preamble, the corresponding RACH occasion, beam indication, UE ID, RA-RNTI, target cell ID and TCI state index for the target cell, and other necessary information to CU 403.

In operation 427, CU 403 may transmit the information received from DU 405 in operation 425 to DU 404 (source DU). For example, CU 403 may transfer the received information to DU 404 via F1 interface. As stated above, the received information may include the TA value related to the candidate cell.

In some embodiments, DU 404 (source DU) may be indicated to transmit the TA value related to the candidate cell to UE 401 via an RAR while DU 404 transmits a cell switching command related to the same candidate cell to UE 401. For example, DU 404 (source DU) is indicated to transmit the TA value related to the candidate cell to UE 401 via an RAR MAC CE, but DU 404 has to transmit a cell switching command related to the same candidate cell to UE 401 right now.

In some embodiments, DU 404 may transmit the cell switching command including the TA value to UE 401 in operation 429 and skip the transmission of the RAR. In some embodiments, DU 404 may transmit the cell switching command without the TA value to UE 401 in operation 429 and skip the transmission of the RAR. In some embodiments, DU 404 may multiplex the cell switching command and the RAR into the same MAC layer data unit (e.g., the same MAC protocol data unit (PDU)) and transmit the MAC layer data unit to UE 401 in operation 429.

In some embodiments, UE 401 may perform cell switch to a candidate cell in response to receiving a cell switching command related to the candidate cell.

It should be appreciated by persons skilled in the art that the sequence of the operations in exemplary procedure 400 may be changed and that some of the operations in exemplary procedure 400 may be eliminated or modified, without departing from the spirit and scope of the disclosure.

FIG. 5 illustrates a flow chart of exemplary procedure 500 for early TA acquisition in accordance with some embodiments of the present disclosure. Details described in all of the foregoing embodiments of the present disclosure are applicable for the embodiments shown in FIG. 5.

As shown in FIG. 5, in operation 511, UE 501 may access BS 502 (i.e., serving BS) and may transmit a measurement report to BS 502. BS 502 may include a CU (i.e., CU 503) and at least one DU (e.g., DU 504 and DU 505). BS 502 may include one or more DUs (not shown in FIG. 7) other than DU 504 and DU 505. Each of DU 504 and DU 505 may include one or more cells, which can also be referred to as the cells of BS 502. UE 501 may be served by a cell of DU 504; and this cell can be referred to as the serving cell of UE 501 and DU 504 can be referred to as the serving DU of UE 501 and can be referred to as the source DU of UE 501.

In operation 513, BS 502 (e.g., CU 503) may determine to initiate a L1/L2 based inter-cell mobility configuration (e.g., LTM configuration) and transmit a request message (e.g., a UE CONTEXT SETUP REQUEST message) to one or more candidate DUs (e.g. DU 505) which are associated with one or more candidate cells. In some embodiments, the request message may indicate an early TA acquisition. That is, a TA value related to a candidate cell may be acquired before the cell switch procedure associated with the candidate cell.

If DU 505 decides to accept the request of LTM configuration related to a candidate cell (i.e., a cell of DU 505), DU 505 may generate a lower layer RRC configuration for the accepted candidate cell. In operation 515, DU 505 may transmit a response message including the generated lower layer RRC configuration (also referred to as “candidate cell configuration for LTM”) to CU 503. In some embodiments, RACH resource for early TA acquisition may be included in the response message. In some embodiments, the response message may be a UE CONTEXT SETUP RESPONSE message.

In operations 517 and 519, CU 503 may transmit the received configurations to DU 504 (source DU) and UE 501. For example, in some embodiments, CU 503 may generate an RRC reconfiguration message based on the received configuration(s) for the candidate cell(s). For example, the RRC reconfiguration message may include the candidate cell configuration(s) for LTM, the RACH resource for early TA acquisition, the RAR related information (if configured) or any combination thereof. In operations 517 and 519, CU 503 may transmit the generated configuration to DU 504 (source DU) and UE 501. For example, CU 503 may transmit the generated configuration to UE 501 via DU 504. In some embodiments, CU 503 may further indicate whether early TA acquisition should be triggered.

In operation 519, UE 501 may receive the RRC configuration message associated with one or more candidate cells for LTM configuration.

In operation 521, UE 501 may receive, from its serving cell or serving DU (e.g., DU 504), an indication for triggering TA acquisition to a specific candidate cell among the one or more candidate cells. The indication may be a PDCCH order associated with the candidate cell. For simplicity, it is assumed that the candidate cell is a cell of DU 505 (candidate DU). In response to the PDCCH order, UE 501 may, in operation 523, transmit a signal (e.g., a preamble for (early) TA acquisition) to DU 505 (i.e., to the corresponding candidate cell).

In response to receive the signal (e.g., the preamble), DU 505 (or the candidate cell) may transmit a TA value related to the candidate cell to CU 503 in operation 525. For example, in the case that DU 505 (or the candidate cell) can calculate or generate a TA value related to the candidate cell based on the received preamble, DU 505 (or the candidate cell) may transmit the calculated TA value to CU 503. In some embodiments, DU 505 (or the candidate cell) may also transmit one of more of: the received preamble, the corresponding RACH occasion, beam indication, UE ID, RA-RNTI, target cell ID and TCI state index for the target cell, and other necessary information to CU 503.

In some other embodiments, in the case that DU 505 (candidate DU) cannot calculate the TA value based on the received preamble, RACH resource may be transmitted to DU 504 (source DU) via CU 503. In some embodiments, in the case that DU 505 (candidate DU) cannot receive the preamble in the configured RACH occasions (ROs), DU 505 (candidate DU) may indicate the failure to DU 504 (source DU) via CU 503. Then, DU 504 (source DU) may trigger a TA re-acquisition. Alternatively, an explicit indication can be used by DU 505 (candidate DU) to indicate a TA re-acquisition. DU 504 (or serving cell) may transmit a PDCCH order to UE 501 again.

In operation 527, CU 503 may transmit the information received from DU 505 in operation 525 to DU 504 (source DU). For example, CU 503 may transfer the received information to DU 504 via F1 interface. As stated above, the received information may include the TA value related to the candidate cell.

In operation 529, DU 504 (source DU) may transmit the TA value to UE 501 via, for example, an RAR MAC CE. In some embodiments, UE 501 may successfully receive the TA value from the serving cell. For example, in the case that UE 501 receives the TA value within the RAR window, UE 501 may determine a successful reception of the TA value. In response to the determination or the successful reception of the TA value, UE 501 may transmit an indication of successful reception of the TA value to BS 502. In some embodiments, the indication may be transmitted via a LI indication, an MAC CE, or an RRC message.

In some embodiments, UE 501 may receive the (early) TA value related to the candidate cell (denoted as cell #2) via an RAR. In some examples, UE 501 then does not expect to receive another (early) TA value related to the same candidate cell (i.e., cell #2) in a cell switching command related to cell #2. In some examples, UE 501 may receive another (early) TA value related to the same candidate cell (i.e., cell #2) in a cell switching command related to cell #2. UE 501 may then use the latest TA value for cell #2. For example, UE 501 may replace the TA value related to cell #2 stored at UE 501 with the another TA value. Put it another way, when a TA field is configured to be present in the cell switching command, UE 501 may use the TA value indicated by the TA field in the cell switching command even it has receives already an (early) TA related to the same cell via an RAR.

In some embodiments, when a candidate cell (denoted as cell #3) determines that the TA value related to cell #3 stored in UE 501 is invalid, cell #3 (or DU of cell #3) can indicate DU 504 (source DU) to trigger a TA acquisition. DU 504 (source DU) can transmit a PDCCH order to UE 501 for TA re-acquisition. From the perspective of UE 501, UE 501 may receive a PDCCH order associated with cell #3, wherein the PDCCH order triggers a TA re-acquisition. UE 501 may delete stored TA value related to cell #3 in response to receiving the PDCCH order.

In some other embodiments, UE 501 may fail to receive the TA value from the serving cell. For example, in the case that UE 501 does not receive the TA value within the RAR window, UE 501 may determine an unsuccessful reception of the TA value. UE 501 may transmit an indication of an unsuccessful reception of the TA value (or a failure in receiving the TA value) to BS 502 in response to the determination or the unsuccessful reception of the TA value. In some embodiments, the indication may be transmitted via a L1 indication, an MAC CE, or an RRC message.

It should be appreciated by persons skilled in the art that the sequence of the operations in exemplary procedure 500 may be changed and that some of the operations in exemplary procedure 500 may be eliminated or modified, without departing from the spirit and scope of the disclosure.

FIG. 6 illustrates a flow chart of exemplary procedure 600 for early TA acquisition in accordance with some embodiments of the present disclosure. Details described in all of the foregoing embodiments of the present disclosure are applicable for the embodiments shown in FIG. 6.

As shown in FIG. 6, in operation 611, UE 601 may access BS 602 (i.e., serving BS) and may transmit a measurement report to BS 602. BS 602 may include a CU (i.e., CU 603) and at least one DU (e.g., DU 604 and DU 605). BS 602 may include one or more DUs (not shown in FIG. 7) other than DU 604 and DU 605. Each of DU 604 and DU 605 may include one or more cells, which can also be referred to as the cells of BS 602. UE 601 may be served by a cell of DU 604; and this cell can be referred to as the serving cell of UE 601 and DU 604 can be referred to as the serving DU of UE 601 and can be referred to as the source DU of UE 601.

In operation 613, BS 602 (e.g., CU 603) may determine to initiate a L1/L2 based inter-cell mobility configuration (e.g., LTM configuration) and transmit a request message (e.g., a UE CONTEXT SETUP REQUEST message) to one or more candidate DUs (e.g. DU 605) which are associated with one or more candidate cells. In some embodiments, the request message may indicate an early TA acquisition. That is, a TA value related to a candidate cell may be acquired before the cell switch procedure associated with the candidate cell.

If DU 605 decides to accept the request of LTM configuration related to a candidate cell (i.e., a cell of DU 605), DU 605 may generate a lower layer RRC configuration for the accepted candidate cell. In operation 615, DU 605 may transmit a response message including the generated lower layer RRC configuration (also referred to as “candidate cell configuration for LTM”) to CU 603. In some embodiments, RACH resource for early TA acquisition may be included in the response message. In some embodiments, the response message may be a UE CONTEXT SETUP RESPONSE message.

In operations 617 and 619, CU 603 may transmit the received configurations to DU 604 (source DU) and UE 601. For example, in some embodiments, CU 603 may generate an RRC reconfiguration message based on the received configuration(s) for the candidate cell(s). For example, the RRC reconfiguration message may include the candidate cell configuration(s) for LTM, the RACH resource for early TA acquisition, the RAR related information (if configured) or any combination thereof. In operations 617 and 619, CU 603 may transmit the generated configuration to DU 604 (source DU) and UE 601. For example, CU 603 may transmit the generated configuration to UE 601 via DU 604. In some embodiments, CU 603 may further indicate whether early TA acquisition should be triggered.

In operation 619, UE 601 may receive the RRC configuration message associated with one or more candidate cells for LTM configuration.

In operation 621, UE 601 may perform a compliance check on the RRC configuration message. For example, the compliance check may be performed on one or more of: the reference configuration, the RACH configuration for early TA acquisition, candidate cell configuration, and complete LTM configuration. For example, the compliance check on the RACH configuration for early TA acquisition associated with a candidate cell may be performed in response to the reception of the RACH configuration or in response to the reception of the PDCCH order associated with the candidate cell.

In some embodiments, in response to a failure in the compliance check, UE 601 may report failure information associated with the compliance check to BS 602. For example, UE 601 may report a cause of the compliance check failure. For example, UE 601 may report an indication indicating one of the following to BS 602: a compliance check failure, a reconfiguration failure, a reference configuration failure, a RACH configuration failure for early TA acquisition, a LTM configuration failure.

In some embodiments, in response to a failure in a compliance check on a master cell group (MCG) configuration, UE 601 may perform a re-establishment procedure. UE 601 may continue to use the configuration used prior to the time when the inability to comply with the RRC reconfiguration message is detected. That is, UE 601 may use the current configuration, instead of the configuration received in operation 619.

In some embodiments, in response to a failure in a compliance check on the MCG configuration, a secondary cell group (SCG) failure information procedure is initiated if the MCG is not suspended. Otherwise, UE may perform a re-establishment procedure. And UE 601 may continue to use the configuration used prior to the time when the inability to comply with the RRC reconfiguration message is detected. That is, UE 601 may use the current configuration, instead of the configuration received in operation 619.

It should be appreciated by persons skilled in the art that the sequence of the operations in exemplary procedure 600 may be changed and that some of the operations in exemplary procedure 600 may be eliminated or modified, without departing from the spirit and scope of the disclosure.

Exemplary procedures 300-600 in FIGS. 3-6 are described with respect to the inter-DU mobility scenario. Persons skilled in the art can readily understand that exemplary procedures 300-600 can be similarly applied to the intra-DU mobility scenario. For example, in exemplary procedure 300 in FIG. 3, DU 304 and DU 305 may be the same DU of BS 302. Thus, interactions between DU 304 and DU 305 can be omitted. For example, operations 315 and 317 and operations 325 and 327 in FIG. 3 can be omitted.

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. Exemplary procedure 700 may be performed by a BS (e.g., a DU of the BS).

Referring to FIG. 7, in operation 711, a first DU of a BS may receive, from a CU of the BS, configuration information regarding early TA acquisition with a candidate cell for cell switching. For example, the first DU may function as DU 304 in FIG. 3, DU 404 in FIG. 4, DU 504 in FIG. 5 or DU 604 in FIG. 6. For example, the descriptions regarding operation 317 in FIG. 3, operation 417 in FIG. 4, operation 517 in FIG. 5 and operation 617 in FIG. 6 may be applied to operation 711.

In operation 713, the first DU may transmit, to a UE served by the first DU, a PDCCH order associated with the candidate cell, wherein the PDCCH order triggers the UE to transmit a signal (e.g., a preamble) to the candidate cell. For example, the signal (e.g., a preamble) may be transmitted via a configured RO. For example, the UE may function as UE 301 in FIG. 3, UE 401 in FIG. 4, UE 501 in FIG. 5 or UE 601 in FIG. 6. For example, the descriptions regarding operation 321 in FIG. 3, operation 421 in FIG. 4 and operation 521 in FIG. 5 may be applied to operation 713.

In some embodiments, in response to transmitting the PDCCH order, the first DU may receive a TA value (e.g., an early TA value) related to the candidate cell from the candidate cell; and perform one of the following: receiving, from the candidate cell, a first indication (e.g., indication #1) indicating whether the TA value is to be transmitted to the UE via an RAR, an MAC CE or a cell switching command, and transmitting the TA value to the UE according to the first indication; transmitting the TA value to the UE via the cell switching command in the case that the first DU does not receive the first indication; receiving, from the CU, a second indication (e.g., indication #2) indicating whether the TA value is to be transmitted to the UE via the RAR, a MAC CE or the cell switching command, and transmitting the TA value to the UE according to the second indication; transmitting the TA value to the UE via the cell switching command in the case that the first DU does not receive the second indication; transmitting the TA value to the UE via the RAR in the case that the first DU receives RAR related information from the CU or the candidate cell; or transmitting the TA value to the UE via the cell switching command in the case that the first DU does not receive any RAR related information.

In some embodiments, the first DU may receive RAR related information from a candidate DU via the CU, or configure the RAR related information for the UE; and transmit the RAR related information to the UE for monitoring an RAR carrying a TA value from a serving cell of the UE.

In some embodiments, the RAR related information may include a length of an RAR window for monitoring the RAR, an offset associated with the RAR window, or both.

In some embodiments, the first DU may receive a TA value related to the candidate cell from the candidate cell in response to transmitting the PDCCH order; and transmit the TA value to the UE via an RAR using one of a C-RNTI, a RA-RNTI or a specific RNTI associated with a serving cell of the UE.

In some embodiments, in the case that the first DU is indicated to transmit a TA value related to the candidate cell to the UE via an RAR while the first DU transmits a cell switching command related to the candidate cell to the UE, the first DU may: transmit the cell switching command including the TA value and skip the transmission of the RAR; transmit the cell switching command without the TA value and skip the transmission of the RAR; or multiplex the cell switching command and the RAR into the same MAC layer data unit (e.g., an MAC PDU).

It should be appreciated by persons skilled in the art that the sequence of the operations in exemplary procedure 700 may be changed and that some of the operations in exemplary procedure 700 may be eliminated or modified, without departing from the spirit and scope of the disclosure.

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. Exemplary procedure 800 may be performed by a UE.

Referring to FIG. 8, in operation 811, a UE may receive a PDCCH order associated with a candidate cell for cell switching. For example, the UE may function as UE 301 in FIG. 3, UE 401 in FIG. 4, UE 501 in FIG. 5 or UE 601 in FIG. 6. For example, the descriptions regarding operation 321 in FIG. 3, operation 421 in FIG. 4 and operation 521 in FIG. 5 may be applied to operation 811.

In operation 813, the UE may transmit a signal (e.g., a preamble) to the candidate cell in response to receiving the PDCCH order. For example, the descriptions regarding operation 323 in FIG. 3, operation 423 in FIG. 4 and operation 523 in FIG. 5 may be applied to operation 813.

In operation 815, the UE may receive a TA value related to the candidate cell via a first DU of a BS, wherein the UE is served by the first DU. For example, the first DU may function as DU 304 in FIG. 3, DU 404 in FIG. 4, DU 504 in FIG. 5 or DU 604 in FIG. 6. For example, the descriptions regarding operation 329 in FIG. 3, operation 429 in FIG. 4 and operation 529 in FIG. 5 may be applied to operation 815.

In some embodiments, the UE may receive RAR related information from a CU of the BS or the first DU, and wherein the RAR related information is configured by the candidate cell or the first DU.

In some embodiments, the RAR related information may include a length of an RAR window for monitoring an RAR carrying the TA value, an offset associated with the RAR window, or both. In some embodiments, a starting time of the RAR window is based on the offset and a duration of the RAR window is based on the length of the RAR window. In some embodiments, the duration of the RAR window is based on the offset and the length of the RAR window.

In some embodiments, in response to a successful reception of the TA value, the UE may transmit an indication of successful reception of the TA value to the BS. In some embodiments, in response to an unsuccessful reception of the TA value, the UE may transmit an indication of an unsuccessful reception of the TA value to the BS. In some embodiments, the indication may be transmitted via a L1 indication, an MAC CE, or an RRC message.

In some embodiments, the TA value may be received via an RAR. In some embodiments, the UE does not expect to receive another TA value related to the candidate cell in a cell switching command related to the candidate cell. In some embodiments, the UE may receive the another TA value in the cell switching command and replace the TA value stored at the UE with the another TA value.

In some embodiments, the UE may receive another PDCCH order associated with the candidate cell, wherein the another PDCCH order triggers a TA re-acquisition; and delete stored TA value related to the candidate cell in response to receiving the another PDCCH order.

In some embodiments, the UE may receive, from the BS, a RACH configuration for the early TA acquisition associated with the candidate cell; and perform a compliance check on the RACH configuration. In some embodiments, the compliance check may be performed in response to the reception of the RACH configuration or in response to the reception of the PDCCH order. In some embodiments, the UE may report failure information indicating one of the following to the BS in response to a failure in the compliance check: a compliance check failure, a reconfiguration failure, a reference configuration failure, a RACH configuration failure for early TA acquisition, a complete LTM configuration failure.

In some embodiments, the TA value may be received via an RAR using a C-RNTI, a RA-RNTI or a specific RNTI associated with a serving cell of the UE.

It should be appreciated by persons skilled in the art that the sequence of the operations in exemplary procedure 800 may be changed and that some of the operations in exemplary procedure 800 may be eliminated or modified, without departing from the spirit and scope of the disclosure.

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. Exemplary procedure 900 may be performed by a BS (e.g., a DU of the BS).

Referring to FIG. 9, in operation 911, a second DU of a BS may receive, from a CU of the BS, a request for cell switching associated with a candidate cell. For example, the second DU may function as DU 305 in FIG. 3, DU 405 in FIG. 4, DU 505 in FIG. 5 or DU 605 in FIG. 6; and the CU may function as CU 303 in FIG. 3, CU 403 in FIG. 4, CU 503 in FIG. 5 or CU 603 in FIG. 6. For example, the descriptions regarding operation 313 in FIG. 3, operation 413 in FIG. 4, operation 513 in FIG. 5 and operation 613 in FIG. 6 may be applied to operation 911.

In operation 913, the second DU may transmit, to the CU, a response, wherein the response includes configuration information associated with the candidate cell. For example, the descriptions regarding operation 315 in FIG. 3, operation 415 in FIG. 4, operation 515 in FIG. 5 and operation 615 in FIG. 6 may be applied to operation 913.

In operation 915, the second DU may receive, from a UE severed by a first DU of the BS, a signal (e.g., a preamble) for early TA acquisition related to the candidate cell. For example, the first DU may function as DU 304 in FIG. 3, DU 404 in FIG. 4, DU 504 in FIG. 5 or DU 604 in FIG. 6. For example, the descriptions regarding operation 323 in FIG. 3, operation 423 in FIG. 4 and operation 523 in FIG. 5 may be applied to operation 915.

In operation 917, the second DU may transmit, to the first DU via the CU, a TA value related to the candidate cell in response to the reception of the signal. For example, the descriptions regarding operations 325 and 327 in FIG. 3, operations 425 and 427 in FIG. 4 and operations 525 and 527 in FIG. 5 may be applied to operation 917.

In some embodiments, the request may indicate that an RAR, an MAC CE or a cell switching command is used to carry the TA value.

In some embodiments, the second DU may transmit a first indication (e.g., indication #1) indicating whether the TA value is to be transmitted to the UE via an RAR, an MAC CE or a cell switching command in response to the reception of the signal.

In some embodiments, the response may further include a length of an RAR window for monitoring an RAR carrying the TA value, an offset associated with the RAR window, or both. In some embodiments, a starting time of the RAR window is based on the offset and a duration of the RAR window is based on the length of the RAR window. In some embodiments, the duration of the RAR window is based on the offset and the length of the RAR window.

It should be appreciated by persons skilled in the art that the sequence of the operations in exemplary procedure 900 may be changed and that some of the operations in exemplary procedure 900 may be eliminated or modified, without departing from the spirit and scope of the disclosure.

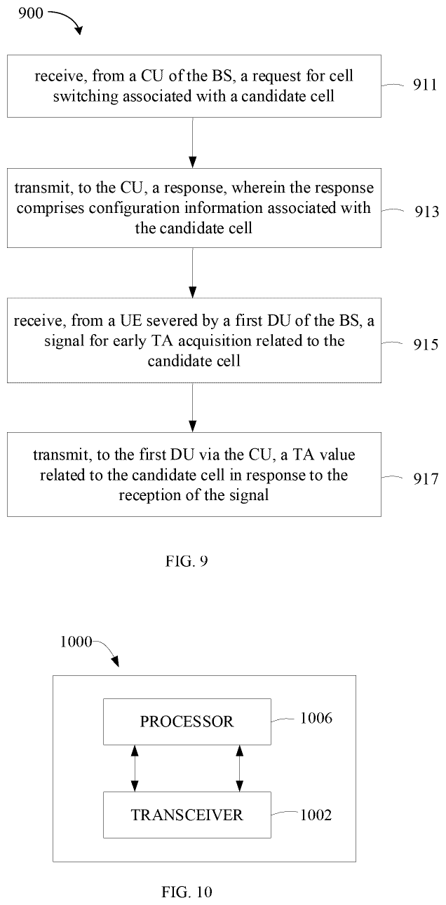

FIG. 10 illustrates a block diagram of exemplary apparatus 1000 according to some embodiments of the present disclosure. As shown in FIG. 10, the apparatus 1000 may include at least one processor 1006 and at least one transceiver 1002 coupled to the processor 1006. The apparatus 1000 may be a UE, a BS, a CU of a BS or a DU of a BS.

Although in this figure, elements such as the at least one transceiver 1002 and processor 1006 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1006 may interact with each other so as to perform the operations with respect to the UE described in FIGS. 1-9. In some embodiments of the present disclosure, the apparatus 1000 may be a BS. The transceiver 1002 and the processor 1006 may interact with each other so as to perform the operations with respect to the BS described in FIGS. 1-9. In some embodiments of the present disclosure, the apparatus 1000 may be a DU of a BS. The transceiver 1002 and the processor 1006 may interact with each other so as to perform the operations with respect to the DU described in FIGS. 1-9. In some embodiments of the present disclosure, the apparatus 1000 may be a CU of a BS. The transceiver 1002 and the processor 1006 may interact with each other so as to perform the operations with respect to the CU described in FIGS. 1-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UE as described above. For example, the computer-executable instructions, when executed, cause the processor 1006 interacting with transceiver 1002 to perform the operations with respect to the UE described in FIGS. 1-9.

In some embodiments of the present disclosure, the non-transitory computer-readable medium may have stored thereon computer-executable instructions to cause the processor 1006 to implement the method with respect to the BS as described above. For example, the computer-executable instructions, when executed, cause the processor 1006 interacting with transceiver 1002 to perform the operations with respect to the BS described in FIGS. 1-9.

In some embodiments of the present disclosure, the non-transitory computer-readable medium may have stored thereon computer-executable instructions to cause the processor 1006 to implement the method with respect to the DU of the BS as described above. For example, the computer-executable instructions, when executed, cause the processor 1006 interacting with transceiver 1002 to perform the operations with respect to the DU of the BS described in FIGS. 1-9.

In some embodiments of the present disclosure, the non-transitory computer-readable medium may have stored thereon computer-executable instructions to cause the processor 1006 to implement the method with respect to the CU of the BS as described above. For example, the computer-executable instructions, when executed, cause the processor 1006 interacting with transceiver 1002 to perform the operations with respect to the CU of the BS described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A first distributed unit (DU) of a base station (BS), comprising:
a least one memory; and
at least one processor coupled with the at least one memory and configured to cause the first DU to:
receive, from a centralized unit (CU) of the BS, configuration information regarding early timing advance (TA) acquisition with a candidate cell for cell switching; and
transmit, to a user equipment (UE) served by the first DU, a physical downlink control channel (PDCCH) order associated with the candidate cell, wherein the PDCCH order triggers the UE to transmit a signal to the candidate cell.

2. The first DU of claim 1, wherein, in response to transmitting the PDCCH order, the at least one processor is further configured to, cause the first DU to:
receive a TA value related to the candidate cell from the candidate cell; and
perform one of the following:
receiving, from the candidate cell, a first indication indicating whether the TA value is to be transmitted to the UE via a random access response (RAR), a medium access control (MAC) control element (CE) or a cell switching command, and transmitting the TA value to the UE according to the first indication;
transmitting the TA value to the UE via the cell switching command in the case that the first DU does not receive the first indication;
receiving, from the CU, a second indication indicating whether the TA value is to be transmitted to the UE via the RAR, a MAC CE or the cell switching command, and transmitting the TA value to the UE according to the second indication;
transmitting the TA value to the UE via the cell switching command in the case that the first DU does not receive the second indication;
transmitting the TA value to the UE via the RAR in the case that the first DU receives RAR related information from the CU or the candidate cell; or
transmitting the TA value to the UE via the cell switching command in the case that the first DU does not receive any RAR related information.

3. The first DU of claim 1, wherein the at least one processor is further configured to cause the first DU to:
receive random access response (RAR) related information from a candidate DU via the CU, or configure the RAR related information for the UE; and
transmit the RAR related information to the UE for monitoring an RAR carrying a TA value from a serving cell of the UE.

4. The first DU of claim 2, wherein the RAR related information comprises a length of an RAR window for monitoring the RAR, an offset associated with the RAR window, or both.

5. The first DU of claim 1, wherein the at least one processor is further configured to cause the first DU to:
receive a TA value related to the candidate cell from the candidate cell in response to transmitting the PDCCH order; and
transmit the TA value to the UE via a random access response (RAR) using one of a cell radio network temporary identifier (C-RNTI), a random access RNTI (RA-RNTI) or a specific RNTI associated with a serving cell of the UE.

6. The first DU of claim 1, wherein, when the first DU is indicated to transmit a TA value related to the candidate cell to the UE via a random access response (RAR) while the first DU transmits a cell switching command related to the candidate cell to the UE, the at least one processor is further configured to cause the first DU to:
transmit the cell switching command including the TA value and skip the transmission of the RAR;
transmit the cell switching command without the TA value and skip the transmission of the RAR; or
multiplex the cell switching command and the RAR into the same medium access control (MAC) layer data unit.

7. A user equipment (UE) for wireless communication, comprising:
at least one memory; and
at least one processor coupled with the at least one memory and configured to cause the UE to:
receive a physical downlink control channel (PDCCH) order associated with a candidate cell for cell switching;
transmit a signal to the candidate cell in response to receiving the PDCCH order; and
receive a timing advance (TA) value related to the candidate cell via a first distributed unit (DU) of a base station (BS), wherein the UE is served by the first DU.

8. The UE of claim 7, wherein the at least one processor is further configured to cause the UE to receive random access response (RAR) related information from a centralized unit (CU) of the BS or the first DU, and wherein the RAR related information is configured by the candidate cell or the first DU.

9. The UE of claim 8, wherein the RAR related information comprises a length of an RAR window for monitoring an RAR carrying the TA value, an offset associated with the RAR window, or both.

10. The UE of claim 9, wherein a starting time of the RAR window is based on the offset and a duration of the RAR window is based on the length of the RAR window; or
wherein the duration of the RAR window is based on the offset and the length of the RAR window.

11. The UE of claim 7, wherein the at least one processor is further configured to cause the UE to:
in response to a successful reception of the TA value, transmit an indication of successful reception of the TA value to the BS; or
in response to an unsuccessful reception of the TA value, transmit an indication of an unsuccessful reception of the TA value to the BS.

12. (canceled)

13. The UE of claim 7, wherein the TA value is received via a random access response (RAR); and
wherein the UE does not expect to receive another TA value related to the candidate cell in a cell switching command related to the candidate cell, or
wherein the processor is further configured to receive the another TA value in the cell switching command and replace the TA value stored at the UE with the another TA value.

14. The UE of claim 7, wherein the at least one processor is further configured to cause the UE to:
receive another PDCCH order associated with the candidate cell, wherein the another PDCCH order triggers a TA re-acquisition; and
delete stored TA value related to the candidate cell in response to receiving the another PDCCH order.

15. The UE of claim 7, wherein the at least one processor is further configured to cause the UE to:
receive, from the BS, a random access channel (RACH) configuration for the early TA acquisition associated with the candidate cell; and
perform a compliance check on the RACH configuration.

16. (canceled)

17. (canceled)

18. (canceled)

19. A second distributed unit (DU) of a base station (BS), comprising:
least one memory; and
at least one processor coupled with the at least one memory and configured to cause the second DU to:
receive, from a centralized unit (CU) of the BS, a request for cell switching associated with a candidate cell;
transmit, to the CU, a response, wherein the response comprises configuration information associated with the candidate cell;
receive, from a user equipment (UE) severed by a first DU of the BS, a signal for early timing advance (TA) acquisition related to the candidate cell; and
transmit, to the first DU via the CU, a TA value related to the candidate cell in response to the reception of the signal.

20. (canceled)

21. The second DU of claim 19, wherein the at least one processor is further configured to cause the second DU to:
transmit, to the CU, additional information, including: a received preamble, a corresponding random access channel (RACH) occasion, a beam indication, a UE ID, a random access-cell radio network temporary identifier (RA-RNTI), a candidate cell ID, or a transmission configuration indication (TCI) state index for the candidate cell.

22. The first DU of claim 11, wherein the at least one processor is further configured to cause the first DU to:
receive, from the CU, additional information, including: a received preamble, a corresponding random access channel (RACH) occasion, a beam indication, a UE ID, a random access-cell radio network temporary identifier (RA-RNTI), a candidate cell ID, or a transmission configuration indication (TCI) state index for the candidate cell.

23. A centralized unit (CU) of a base station (BS), comprising:
at least one memory; and
at least one processor coupled with the at least one memory and configured to cause the CU to:
receive, from a candidate distributed unit (DU), timing advance (TA) related information; and
transmit the TA related information to a source DU.

24. The CU of claim 23, wherein the at least one processor is further configured to cause the CU to:
receive, from the candidate DU, additional information, including: a received preamble, a corresponding random access channel (RACH) occasion, a beam indication, a UE ID, a random access-cell radio network temporary identifier (RA-RNTI), a candidate cell ID, or a transmission configuration indication (TCI) state index for the candidate cell.

25. The CU of claim 23, wherein the at least one processor is further configured to cause the CU to:
transmit, to the source DU, additional information, including: a received preamble, a corresponding random access channel (RACH) occasion, a beam indication, a UE ID, a random access-cell radio network temporary identifier (RA-RNTI), a candidate cell ID, or a transmission configuration indication (TCI) state index for the candidate cell.
